(19) United States
(12) Patent Application Publication
(10) Pub. No.: US 2014/0055773 A1
(43) Pub. Date: Feb. 27, 2014

(54) METHOD AND DEVICE FOR INSPECTING GLASS SUBSTRATE OF LIQUID CRYSTAL DISPLAY

(71) Applicants: Zhengcai Chen, Shenzhen (CN); Chunjiang Li, Shenzhen (CN)

(72) Inventors: Zhengcai Chen, Shenzhen (CN); Chunjiang Li, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/700,159

(22) PCT Filed: Sep. 13, 2012
(86) PCT No.: PCT/CN2012/081312

§ 371 Date: Nov. 27, 2012

(30) Foreign Application Priority Data
Aug. 21, 2012 (CN) 201210299155.0

(51) Int. Cl. G01N 21/88

(52) U.S. Cl. CPC G01N 21/8803
USPC 356/36

(57) ABSTRACT

The present invention provides a method and a device for inspecting glass substrate of liquid crystal display. The method includes (1) providing an inspection device, wherein the inspection device comprises a device body, an operation table mounted on the device body, an irradiation lamp mounted to the device body and located above the operation table, and a steam nozzle mounted to the device body and located above the operation table, the operation table having a bearing surface, the bearing surface forming an included angle with respect to the horizon; (2) positioning a glass substrate-to-be-inspected on the bearing surface; and (3) turning on the irradiation lamp and spraying steam through the steam nozzle toward the glass substrate-to-be-inspected and at the same time, performing visual inspection of the glass substrate to which the steam attaches.

### BACKGROUND OF THE INVENTION

1. Field of the Invention

The present invention relates to the field of manufacture of liquid crystal display, and in particular to a method and device for inspecting glass substrate of liquid crystal display.

2. The Related Arts

Liquid crystal display (LCD) has a variety of advantages, such as thin device body, low power consumption, and being free of radiation, and is thus widely used. Most of the LCDs that are currently available in the market are backlighting LCDs, which comprise a liquid crystal display panel and a backlight module. The operation principle of the liquid crystal display panel is that liquid crystal molecules are interposed between two parallel glass substrates and electricity is applied to the glass substrates to control variation of orientation of the liquid crystal molecules in order to refract light emitting from the backlight module for generating images.

A liquid crystal display panel is generally composed of an upper substrate (color filter substrate), a lower substrate (thin film transistor (TFT) substrate), and liquid crystal (LC) and sealant interposed between the upper substrate and the lower substrate. A general manufacturing process comprises a front stage of array process (including thin film, yellow light, etching, and film stripping), an intermediate stage of cell process (including bonding TFT substrate and the CF substrate), and a rear stage of assembling process (including mounting drive ICs and printed circuit board). The front stage of array process generally makes the TFT substrate for controlling the movement of liquid crystal molecules. The intermediate stage of cell process generally introduces the liquid crystal between the TFT substrate and the CF substrate. The rear stage of assembling process generally integrates the drive ICs and the printed circuit board to drive the liquid crystal molecules to rotate for displaying images.

In the front stage of array process, defect inspection must be first carried out on the glass substrate. Currently, visual inspection of the glass substrate aided by light is adopted in the TFT-LCD industry. Referring to FIG. 1, which is a schematic view illustrating a known way of inspecting defects of a glass substrate through light reflection, a lamp 100 irradiates light on a glass substrate 300 to be scattered and an inspection operator 500 visually inspects defects, such as inhomogeneous luminance, scratch, and stain, on the glass substrate 300. Referring to FIG. 2, which is a schematic view illustrating a known way of inspecting defects of a glass substrate through light transmission, a lamp 100′ irradiates light on a glass substrates 300′ to allow the light to transmit through the glass substrate 300′. An inspection operator 500′ visually observe the homogeneity of the light transmitting through the glass substrate 300′ to identify defects of the glass substrate 300′, such as inhomogeneous luminance, scratch, and stain.

However, since the surface of the glass substrate of liquid crystal display is of extremely high transmittance (approximately higher than 90%) and excellent surface smoothness. Such factors make it only possible to identify apparent macro defects by using the two above described processes. It is not possible to find out any potential defects of the glass substrate.

### SUMMARY OF THE INVENTION

An object of the present invention is to provide a method for inspecting glass substrate of liquid crystal display, which effectively identifies both macro defects and potential defects existing in a glass substrate of liquid crystal display in order to ensure the quality of the liquid crystal display.

Another object of the present invention is to provide a device for inspecting glass substrate of liquid crystal display, which has a simple structure, is easy to operate, and effectively identifies potential defects existing in a glass substrate of liquid crystal display.

To achieve the object, the present invention provides a method for inspecting glass substrate of liquid crystal display, which comprises the following steps:

Step 1: providing an inspection device, wherein the inspection device comprises a device body, an operation table mounted on the device body, an irradiation lamp mounted to the device body and located above the operation table, and a steam nozzle mounted to the device body and located above the operation table, the operation table having a bearing surface, the bearing surface forming an included angle with respect to the horizon;

Step 2: positioning a glass substrate-to-be-inspected on the bearing surface; and

Step 3: turning on the irradiation lamp and spraying steam through the steam nozzle toward the glass substrate-to-be-inspected and at the same time, performing visual inspection of the glass substrate to which the steam attaches.

The inspection device further comprises a storage device mounted to the device body and a heating device mounted to the device body. The storage device stores water therein. The heating device heats up the water stored in the storage device for conversion into steam. The water stored in the storage device is pure water.

In step (3), the visual inspection of the glass substrate is carried out with the light emitting from the irradiation lamp and reflected by the glass substrate to which the steam attaches.

The steam nozzle is connected by a hose to the storage device.

The inspection device further comprises an electrical control device mounted to the device body and electrically connected to the heating device.

The present invention also provides a method for inspecting glass substrate of liquid crystal display, which comprises the following steps:

Step 1: providing an inspection device, wherein the inspection device comprises a device body, an operation table mounted on the device body, an irradiation lamp mounted to the device body and located above the operation table, and a steam nozzle mounted to the device body and located above the operation table, the operation table having a bearing surface, the bearing surface forming an included angle with respect to the horizon;

Step 2: positioning a glass substrate-to-be-inspected on the bearing surface; and

Step 3: turning on the irradiation lamp and spraying steam through the steam nozzle toward the glass substrate-to-be-inspected and at the same time, performing visual inspection of the glass substrate to which the steam attaches; and

wherein the inspection device further comprises a storage device mounted to the device body and a heating device mounted to the device body, the storage device storing water therein, the heating device heating up the water stored in the storage device for conversion into steam, the water stored in the storage device being pure water;

wherein in step (3), the visual inspection of the glass substrate is carried out with the light emitting from the irradiation lamp and reflected by the glass substrate to which the steam attaches;

wherein the steam nozzle is connected by a hose to the storage device; and

wherein the inspection device further comprises an electrical control device mounted to the device body and electrically connected to the heating device.

The present invention also provides a device for inspect ting glass substrate of liquid crystal display, which comprises a device body, an operation table mounted on the device body, an irradiation lamp mounted to the device body and located above the operation table, and a steam nozzle mounted to the device body and located above the operation table. The operation table has a bearing surface. The bearing surface forms an included angle with respect to the horizon.

The inspection device further comprises a storage device mounted to the device body and a heating device mounted to the device body. The storage device stores water therein. The heating device heats up the water stored in the storage device for conversion into steam.

The water stored in the storage device is pure water.

The steam nozzle is connected by a hose to the storage device.

The inspection device further comprises an electrical control device mounted to the device body and electrically connected to the heating device.

The efficacy of the present invention is that the present invention provides a method and a device for inspecting glass substrate of liquid crystal display, which spray steam on a glass substrate to alleviate mirror reflection of the surface of the glass substrate and enhance scattered reflection so as to allow more light to be reflected toward the range of sight of an inspector operator for improving capability of inspection of the operator and expanding the scope of inspection by the operator thereby effectively identifying macro defects and potential defects of the glass substrate of a liquid crystal display and thus ensuring quality of the liquid crystal display.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, of the present invention will be apparent from the following detailed description of an embodiment of the present invention, with reference to the attached drawings. In the drawings:

FIG. 1 is a schematic view illustrating a known way of inspecting defects of a glass substrate through light reflection;

FIG. 2 is a schematic view illustrating a known way of inspecting defects of a glass substrate through light transmission;

FIG. 3 is a flow chart illustrating a method for inspecting glass substrate of liquid crystal display according to the present invention;

FIG. 4 is a schematic view illustrating inspection of a glass substrate by applying the method for inspecting glass substrate of liquid crystal display according to the present invention; and

FIG. 5 is a schematic view showing a device for inspecting glass substrate of liquid crystal display according to the present invention.

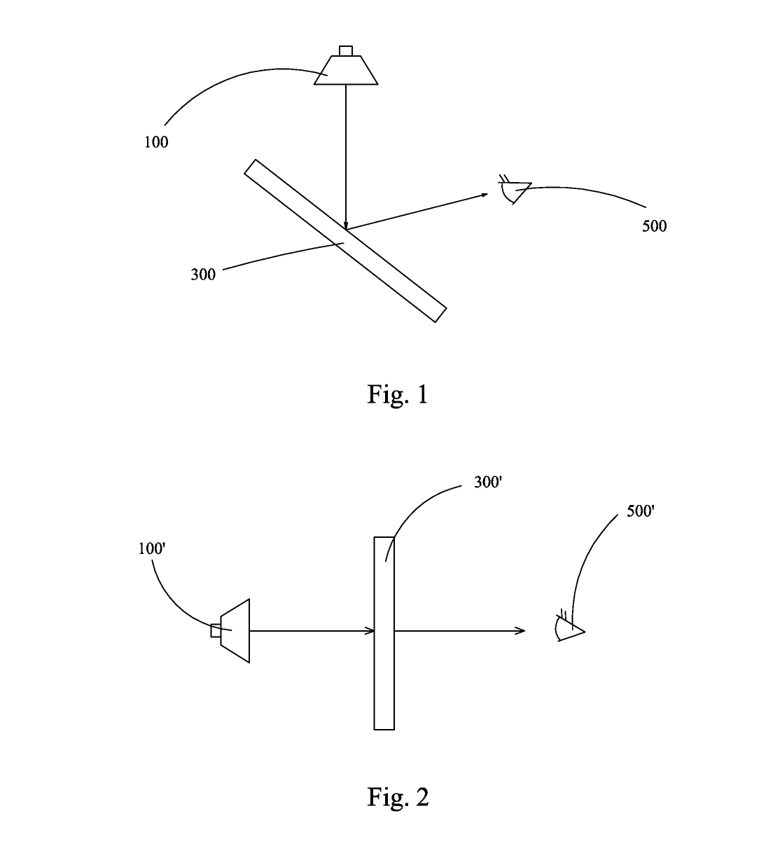

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

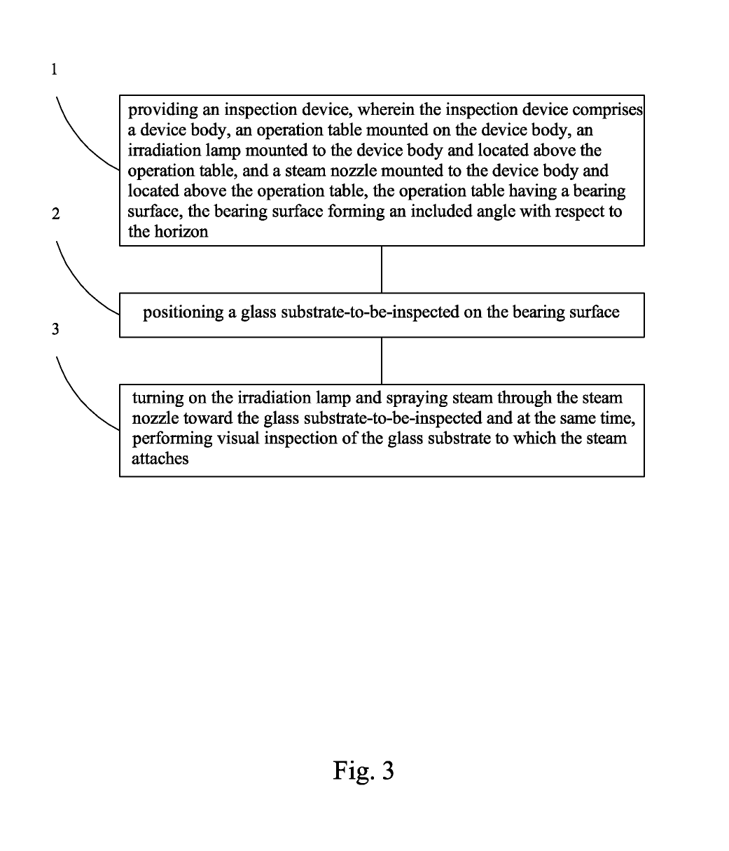

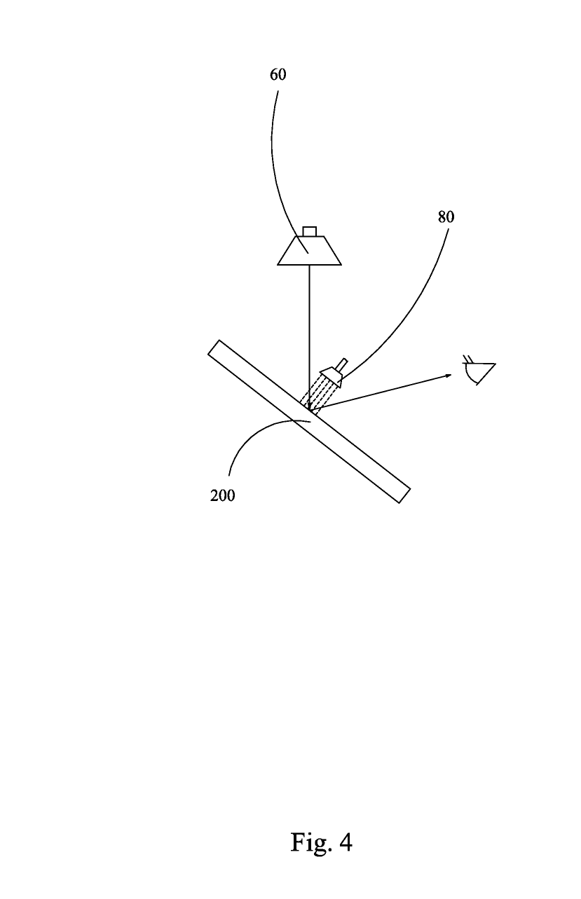

Referring to FIGS. 3-5, the present invention provides a method for inspecting glass substrate of liquid crystal display, which comprises the following steps:

Step 1: providing an inspection device, wherein the inspection device comprises a device body 20, an operation table 40 mounted on the device body 20, an irradiation lamp 60 mounted to the device body 20 and located above the operation table 40, and a steam nozzle 80 mounted to the device body 20 and located above the operation table 40.

The inspection device further comprises a storage device 22 mounted to the device body 20 and a heating device 24 mounted to the device body 20. The storage device 22 stores water therein. The heating device 24 heats up the water stored in the storage device 22 for conversion into steam. The water stored in the storage device 22 is pure water. The steam nozzle 80 is connected by a hose 82 to the storage device 22. The heating device 24 heats up the pure water stored in the storage device 22 to make it converted into steam, which passes through the hose 82 and is sprayed by the steam nozzle 80 onto a glass substrate-to-be-inspected 200.

The inspection device further comprises an electrical control device 26 mounted to the device body 20 and electrically connected to the heating device 24. The electrical control device 26 controls the operation of the heating device 24 for heating the storage device 22.

The operation table 40 has a bearing surface 42. The bearing surface 42 forms an included angle θ with respect to the horizon.

Step 2: positioning a glass substrate-to-be-inspected 200 on the bearing surface 42.

Since an included angle θ is present between the bearing surface 42 and the horizon, the glass substrate-to-be-inspected 200 is also set at an included angle θ with respect to the horizon, allowing an inspector operation to better perform visual inspection of the glass substrate-to-be-inspected 200.

Step 3: Turning on the irradiation lamp 60 and spraying steam through the steam nozzle 80 toward the glass substrate-to-be-inspected 200 and at the same time, performing visual inspection of the glass substrate 200 to which the steam attaches.

Since the glass substrate-to-be-inspected 200 is attached with steam, mirror reflection of the glass substrate-to-be-inspected 200 is alleviated, while scattered reflection is enhanced, whereby the light emitting from the irradiation lamp 60, after subjecting to scattered reflection by the glass substrate-to-be-inspected 200 to which the steam is attached, is allowed to enter, in an increased quantity, into the eyes of the inspection operator for more effectively identifying macro defects and potential defects of the glass substrate 200 of liquid crystal display.

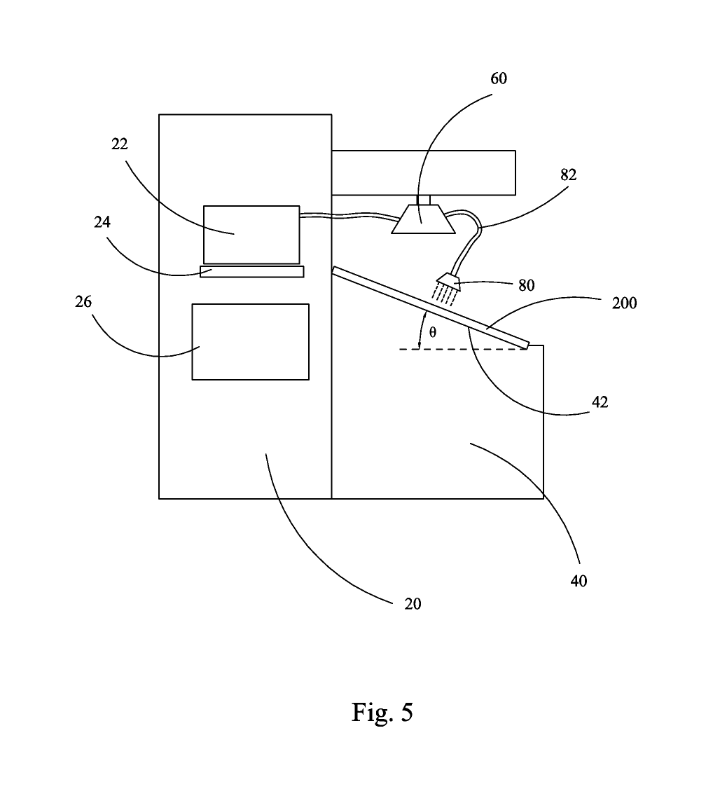

Referring to FIG. 5, the present invention also provides a device for inspecting glass substrate of liquid crystal display, which comprises a device body 20, an operation table 40 mounted on the device body 20, an irradiation lamp 60 mounted to the device body 20 and located above the operation table 40, and a steam nozzle 80 mounted to the device body 20 and located above the operation table 40.

The inspection device further comprises a storage device 22 mounted to the device body 20 and a heating device 24 mounted to the device body 20. The storage device 22 stores water therein. The heating device 24 heats up the water stored in the storage device 22 for conversion into steam. The water stored in the storage device 22 is pure water. The steam nozzle 80 is connected by a hose 82 to the storage device 22. The heating device 24 heats up the pure water stored in the storage device 22 to make it converted into steam, which passes through the hose 82 and is sprayed by the steam nozzle 80 onto a glass substrate-to-be-inspected 200.

The inspection device further comprises an electrical control device 26 mounted to the device body 20 and electrically connected to the heating device 24. The electrical control device 26 controls the operation of the heating device 24 for heating the storage device 22.

The operation table 40 has a bearing surface 42. The bearing surface 42 forms an included angle θ with respect to the horizon. Thus, the glass substrate-to-be-inspected 200 is also set at an included angle θ with respect to the horizon, allowing an inspection operator to better perform visual inspection of the glass substrate-to-be-inspected 200.

In summary, the present invention provides a method and a device for inspecting glass substrate of liquid crystal display, which spray steam on a glass substrate to alleviate mirror reflection of the surface of the glass substrate and enhance scattered reflection so as to allow more light to be reflected toward the range of sight of an inspector operator for improving capability of inspection of the operator and expanding the scope of inspection by the operator thereby effectively identifying macro defects and potential defects of the glass substrate of a liquid crystal display and thus ensuring quality of the liquid crystal display.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for inspecting glass substrate of liquid crystal display, comprising the following steps:
(1) providing an inspection device, wherein the inspection device comprises a device body, an operation table mounted on the device body, an irradiation lamp mounted to the device body and located above the operation table, and a steam nozzle mounted to the device body and located above the operation table, the operation table having a bearing surface, the bearing surface forming an included angle with respect to the horizon;
(2) positioning a glass substrate-to-be-inspected on the bearing surface; and
(3) turning on the irradiation lamp and spraying steam through the steam nozzle toward the glass substrate-to-be-inspected and at the same time, performing visual inspection of the glass substrate to which the steam attaches.

2. The method for inspecting glass substrate of liquid crystal display as claimed in claim 1, wherein the inspection device further comprises a storage device mounted to the device body and a heating device mounted to the device body, the storage device storing water therein, the heating device heating up the water stored in the storage device for conversion into steam, the water stored in the storage device being pure water.

3. The method for inspecting glass substrate of liquid crystal display as claimed in claim 2, wherein in step (3), the visual inspection of the glass substrate is carried out with the light emitting from the irradiation lamp and reflected by the glass substrate to which the steam attaches.

4. The method for inspecting glass substrate of liquid crystal display as claimed in claim 2, wherein the steam nozzle is connected by a hose to the storage device.

5. The method for inspecting glass substrate of liquid crystal display as claimed in claim 2, wherein the inspection device further comprises an electrical control device mounted to the device body and electrically connected to the heating device.

6. A method for inspecting glass substrate of liquid crystal display, comprising the following steps:
(1) providing an inspection device, wherein the inspection device comprises a device body, an operation table mounted on the device body, an irradiation lamp mounted to the device body and located above the operation table, and a steam nozzle mounted to the device body and located above the operation table, the operation table having a bearing surface, the bearing surface forming an included angle with respect to the horizon;
(2) positioning a glass substrate-to-be-inspected on the bearing surface; and
(3) turning on the irradiation lamp and spraying steam through the steam nozzle toward the glass substrate-to-be-inspected and at the same time, performing visual inspection of the glass substrate to which the steam attaches; and
wherein the inspection device further comprises a storage device mounted to the device body and a heating device mounted to the device body, the storage device storing water therein, the heating device heating up the water stored in the storage device for conversion into steam, the water stored in the storage device being pure water;
wherein in step (3), the visual inspection of the glass substrate is carried out with the light emitting from the irradiation lamp and reflected by the glass substrate to which the steam attaches;
wherein the steam nozzle is connected by a hose to the storage device; and
wherein the inspection device further comprises an electrical control device mounted to the device body and electrically connected to the heating device.

7. A device for inspect ting glass substrate of liquid crystal display, comprising a device body, an operation table mounted on the device body, an irradiation lamp mounted to the device body and located above the operation table, and a steam nozzle mounted to the device body and located above the operation table, the operation table having a bearing surface, the bearing surface forming an included angle with respect to the horizon.

8. The device for inspecting glass substrate of liquid crystal display as claimed in claim 7, wherein the inspection device further comprises a storage device mounted to the device body and a heating device mounted to the device body, the storage device storing water therein, the heating device heating up the water stored in the storage device for conversion into steam.

9. The device for inspecting glass substrate of liquid crystal display as claimed in claim 8, wherein the water stored in the storage device is pure water.

10. The device for inspecting glass substrate of liquid crystal display as claimed in claim 8, wherein the steam nozzle is connected by a hose to the storage device.

11. The device for inspecting glass substrate of liquid crystal display as claimed in claim 8, wherein the inspection device further comprises an electrical control device mounted to the device body and electrically connected to the heating device.
